(19) United States
(12) Patent Application Publication
(10) Pub. No.: US 2025/0294098 A1
(43) Pub. Date: Sep. 18, 2025

(54) IMAGE FORMING SYSTEM AND DISCHARGE DESTINATION SETTING APPARATUS

(71) Applicant: CANON KABUSHIKI KAISHA, Tokyo (JP)

(72) Inventor: TAKESHI HONDA, Chiba (JP)

(21) Appl. No.: 19/076,148

(22) Filed: Mar. 11, 2025

(30) Foreign Application Priority Data
Mar. 15, 2024 (JP) 2024-041346

(51) Int. Cl. H04N 1/00

(52) U.S. Cl. CPC H04N 1/00029; H04N 1/00082

(57) ABSTRACT

An image forming system includes an image forming unit configured to form an image on a sheet, a reader configured to read the image formed on the sheet by the image forming unit, an inspector configured to execute an inspection of the image read by the reader, and a selector configured to select a discharge destination to which, after an image formed on a first sheet printed as test printing by the image forming unit is inspected by the inspector, the first sheet is to be discharged, and select a discharge destination to which, after an image formed on a second sheet printed as main printing is inspected by the inspector, the second sheet is to be discharged.

### BACKGROUND OF THE INVENTION

### Field of the Invention

The present disclosure relates to an image forming system having a printing inspection function of performing a quality inspection of an image printed on a sheet and a discharge destination setting apparatus.

### Description of the Related Art

An image forming apparatus executes a print job for generating a printed matter by printing an image on a sheet based on image data representing an image to be printed. In particular, an image forming apparatus for use in a commercial printing site (hereinafter referred to as “production printing machine”) may print a large number of copies or a large number of pages in one print job. Accordingly, it is general to execute test printing for printing only a specific page before main printing.

In US 2021/0365219, it is disclosed that, particularly in a large-scale printing site, a large amount of print jobs are sequentially assigned to production printing machines, and the plurality of machines execute printing processing in parallel. In each of the machines, the main printing is executed after the test printing is executed for each transmitted print job.

A printing inspection apparatus connected to the image forming apparatus inspects whether or not an image printed on a sheet by the image forming apparatus has been formed as instructed by the image data. The printing inspection apparatus executes a printing inspection in accordance with inspection settings, such as an inspection region and an inspection intensity (inspection level), which are set in advance by a user. However, when the items of the inspection that have been set are incorrect (different from those originally intended by the user), there is a possibility that the number of sheets that are determined as having printing abnormalities (inspection NG) as inspection results during the print job may be increased.

In Japanese Patent Application Laid-open No. 2005-144797, when it is determined in the inspection result of the printing inspection apparatus that there is an abnormality (NG) while the main printing is executed, the sheet determined as having NG (NG sheet) is discharged to a dedicated purge tray. After that, processing of re-printing is automatically performed. As described above, in the main printing, through use of the purge tray for discharge of the NG sheet, the NG sheet is automatically removed, and processing of a printing recovery operation is automatically performed so that printing efficiency is improved.

### SUMMARY OF THE INVENTION

An image forming system according to some embodiments of the present disclosure includes an image forming unit configured to form an image on a sheet, a reader configured to read the image formed on the sheet by the image forming unit, an inspector configured to execute an inspection of the image read by the reader, and a selector configured to select a discharge destination to which, after an image formed on a first sheet printed as test printing by the image forming unit is inspected by the inspector, the first sheet is to be discharged, and select a discharge destination to which, after an image formed on a second sheet printed as main printing is inspected by the inspector, the second sheet is to be discharged.

A discharge destination setting apparatus to be used in an image forming system according to another embodiment of the present disclosure including an image forming unit and an inspector configured to execute an inspection of an image obtained by reading an image formed on a sheet by the image forming unit, the discharge destination setting apparatus includes a display, and a display controller configured to cause the display to display a screen, wherein the display is configured to display a screen for use in selecting a discharge destination to which, after an image formed on a first sheet printed as test printing by the image forming unit is inspected by the inspector, the first sheet is to be discharged, and selecting a discharge destination to which, after an image formed on a second sheet printed as main printing is inspected by the inspector, the second sheet to is be discharged.

Further features of the present invention will become apparent from the following description of exemplary embodiments (with reference to the attached drawings.

### BRIEF DESCRIPTION OF THE DRAWINGS

FIG. 1 is a configuration diagram of an image forming system.

FIG. 2 is a configuration diagram of a controller.

FIG. 3 is a configuration diagram of an inspection controller.

FIG. 4 is an explanatory view of a printing setting screen.

FIG. 5 is an explanatory view of an inspection setting screen.

FIG. 6 is an explanatory view of an inspection result setting screen.

FIG. 7 is a flow chart of test printing inspection processing.

FIG. 8 is a flow chart of the test printing inspection processing.

FIG. 9 is a flow chart of main printing inspection processing.

FIG. 10 is a flow chart of the main printing inspection processing.

FIG. 11 is a view for illustrating a modification example of the inspection result setting screen.

FIG. 12 is a view for illustrating another modification example of the inspection result setting screen.

### DESCRIPTION OF THE EMBODIMENTS

Now, at least one embodiment of the present disclosure is described with reference to the accompanying drawings. Further, the at least one embodiment described below does not limit the disclosure according to the appended claims, and not all combinations of features described in the at least one embodiment are necessarily essential to solving means for the disclosure.

### <Configuration of Image Forming System>

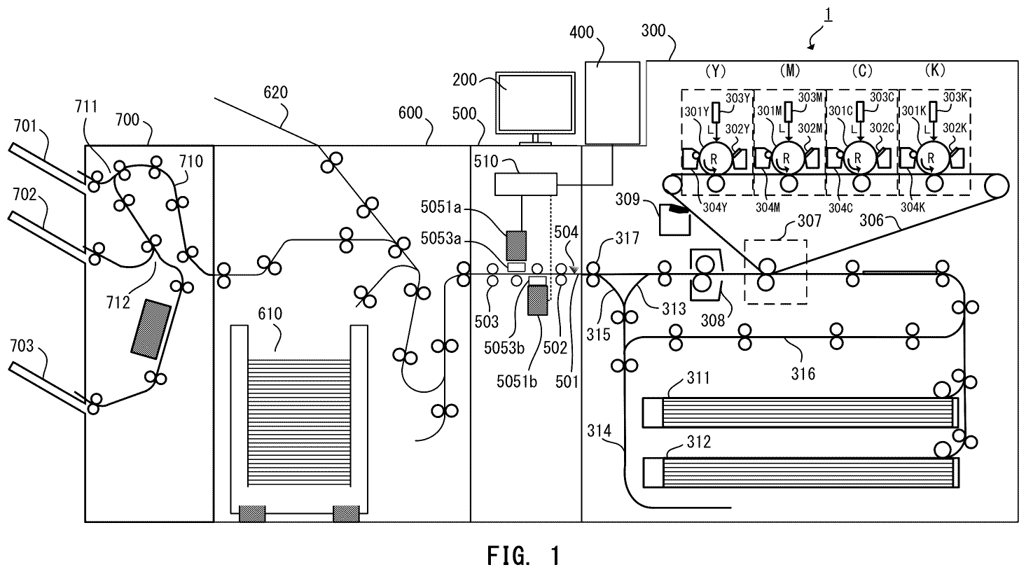

FIG. 1 is a configuration diagram of an image forming system including a printing inspection apparatus according to the at least one embodiment. An image forming system 1 includes an operating device 200, a printer 300 serving as an image forming unit, a controller 400, an inspection apparatus 500 serving as an image inspector, a stacker 600, and a finisher 700 serving as a post-processor.

The operating device 200 is a user interface provided with an input interface and an output interface. The input interface is, for example, an input key and a touch panel. The output interface is, for example, a display and a speaker. Therefore, the operating device 200 functions as means for presenting information through vision and hearing. The operating device 200 transmits, to the controller 400, an instruction and data that have been input from the input interface. In addition, the operating device 200 outputs information from the output interface in response to an instruction received from the controller 400.

The controller 400 controls operations of the printer 300, the inspection apparatus 500, the stacker 600, and the finisher 700 based on instructions and data that have been input from the operating device 200 or instructions and data that have been acquired from an external apparatus through a network. For example, to perform image formation, the controller 400 transmits an instruction for the image formation to the printer 300. Details of the controller 400 are described later.

### <Printer>

The printer 300 in the at least one embodiment is a color image forming apparatus that prints a color image on a sheet, and functions as printing means. The printer 300 includes image forming units Y, M, C, and K, an intermediate transfer member 306, a transfer unit 307, a fixing device 308, sheet feeding cassettes 311 and 312, and a feeding mechanism for the sheet. The image forming unit Y forms an image of yellow (Y). The image forming unit M forms an image of magenta (M). The image forming unit C forms an image of cyan (C). The image forming unit K forms an image of black (K). The images of the respective colors formed by the image forming units Y, M, C, and K are transferred onto the intermediate transfer member 306 in a superimposed manner. The transfer unit 307 transfers the image borne on the intermediate transfer member 306 onto the sheet. The fixing device 308 fixes, to the sheet, the image transferred onto the sheet. The respective image forming units Y, M, C, and K have the same configuration, and form the images by the same operation. The following description is directed to a configuration of the image forming unit Y, and descriptions of configurations of the image forming units M, C, and K are omitted.

The image forming unit Y includes a photosensitive drum 301Y, a charger 302Y, an exposure device 303Y, and a developing device 304Y. The photosensitive drum 301Y is a drum-shaped photosensitive member including a photosensitive layer on a surface thereof. During an operation, the photosensitive drum 301Y is rotated in a direction indicated by an arrow R about a drum axis. The charger 302Y uniformly charges the surface of the photosensitive drum 301Y being rotated. The exposure device 303Y acquires image data representing an image of yellow from the controller 400, and emits and outputs a laser beam in accordance with the image data. The laser beam output from the exposure device 303Y scans the charged surface of the photosensitive drum 301Y in a drum axis direction.

The laser light scans the surface of the photosensitive drum 301Y being rotated, to thereby form an electrostatic latent image corresponding to the image data of yellow on the surface of the photosensitive drum 301Y. The developing device 304Y stores a yellow developer (e.g., toner), and uses the developer to develop the electrostatic latent image formed on the photosensitive drum 301Y. Thus, a yellow image is formed on the surface of the photosensitive drum 301Y. The developing device 304Y is configured so that a developer can be constantly supplied thereto from a toner cartridge (not shown).

In the same manner, a magenta image is formed on a photosensitive drum 301M of the image forming unit M. A cyan image is formed on a photosensitive drum 301C of the image forming unit C. A black image is formed on a photosensitive drum 301K of the image forming unit K. The intermediate transfer member 306 is an endless belt member, and is rotated in a clockwise direction in FIG. 1. The intermediate transfer member 306 is in contact with the respective photosensitive drums 301Y, 301M, 301C, and 301K. In accordance with the rotation of the intermediate transfer member 306, the images of the respective colors are transferred from the respective photosensitive drums 301Y, 301M, 301C, and 301K in order so as to be superimposed one on another. Thus, a full-color image is formed on the intermediate transfer member 306. The intermediate transfer member 306 conveys the full-color image borne thereon to the transfer unit 307 by being rotated.

Sheets are stored in each of the sheet feeding cassettes 311 and 312, and are conveyed from the sheet feeding cassettes 311 and 312 to the transfer unit 307 by the feeding mechanism. A sheet is conveyed in accordance with a timing at which the image borne on the intermediate transfer member 306 is conveyed to the transfer unit 307. The transfer unit 307 transfers the image from the intermediate transfer member 306 onto the sheet. A cleaner 309 is arranged on a downstream side of the transfer unit 307 in a rotation direction of the intermediate transfer member 306. The cleaner 309 removes a developer remaining on the intermediate transfer member 306 after the transfer.

The sheet onto which the image has been transferred is conveyed from the transfer unit 307 to the fixing device 308. The fixing device 308 includes a heater and a pressure roller. The fixing device 308 uses heat from the heater and pressure from the pressure roller to melt the image and fix the image to the sheet.

Conveying paths 313, 314, and 315, a duplex conveying path 316, and discharge rollers 317 are provided on a downstream side of the fixing device 308 in a conveying direction of the sheet. The sheet that has passed through the fixing device 308 is temporarily conveyed from the conveying path 313 to the conveying path 314. After a trailing end of the sheet has passed through the conveying path 313, the conveying direction is reversed to convey the sheet from the conveying path 315 to the discharge rollers 317. With such conveyance, the sheet is discharged from the printer 300 by the discharge rollers 317 with an image-formed side facing downward (face down). A printed matter, which is the sheet that has been subjected to the image formation and discharged from the printer 300 by the discharge rollers 317, is passed over to the inspection apparatus 500.

When duplex printing is to be performed on the sheet, the sheet conveyed to the conveying path 314 is conveyed to the duplex conveying path 316 after the trailing end has passed through the conveying path 313. The sheet is conveyed again to the transfer unit 307 through the duplex conveying path 316. Due to the passage through the duplex conveying path 316, a side of the sheet on which the image has been formed is turned over. The turned-over side of the sheet is subjected to image transferring processing by the transfer unit 307 and fixing processing by the fixing device 308, to thereby form an image on this side. The sheet having images formed on both sides is discharged as a printed matter from the printer 300 by the discharge rollers 317, and is passed over to the inspection apparatus 500.

### <Printing Inspection Apparatus>

The inspection apparatus 500 includes a conveying path 501, an inspection controller 510, a first reader 5051a, a second reader 5051b, flow reading glasses 5053a and 5053b, conveying rollers 502 and 503, and a sheet detection sensor 504. Under the control of the controller 400, the inspection controller 510 controls the operation of the inspection apparatus 500. Details of the inspection controller 510 are described later. The first reader 5051a and the second reader 5051b are arranged at positions opposed to each other across the conveying path 501. The conveying rollers 502 and 503 convey the printed matter.

The inspection apparatus 500 detects the printed matter conveyed on the conveying path 501 by the sheet detection sensor 504, and the first reader 5051a and the second reader 5051b read the print images. The first reader 5051a and the second reader 5051b transmit reading results of the printed matter to the inspection controller 510. The inspection controller 510 performs a quality inspection of the images printed on the printed matter based on the reading results of the printed matter. The first reader 5051a and the second reader 5051b are arranged so as to be opposed to each other across the conveying path 501, and hence the images printed on both sides of the printed matter are read in one time of conveyance of the printed matter. The printed matter from which the images have been read is conveyed from the inspection apparatus 500 to the stacker 600.

### <Stacker and Finisher>

The stacker 600 includes a large-capacity tray 610 and a purge tray 620. The stacker 600 discharges a printed matter to any one of the large-capacity tray 610, the finisher 700, and the purge tray 620 based on an instruction received from the controller 400 and the results of the quality inspection performed by the inspection controller 510.

The finisher 700 includes a printed matter conveyor 710 including a plurality of conveying rollers and conveying paths, an upper-stage delivery tray 701, a middle-stage delivery tray 702, and a lower-stage delivery tray 703. The printed matter conveyor 710 includes switching mechanisms 711 and 712 for switching a discharge destination of the printed matter. The finisher 700 takes in printed matters from the stacker 600 in order, and discharges each of the printed matters to any one of the upper-stage delivery tray 701, the middle-stage delivery tray 702, and the lower-stage delivery tray 703 in response to an instruction received from the controller 400. Each of the stacker 600 and the finisher 700 has a shift discharge function to allow an operator to easily discriminate the sheet bundles at the time of discharge. Further, each of the stacker 600 and the finisher 700 may be configured to perform post-processing, such as staple processing for binding and stapling a plurality of printed matters, bookbinding processing for the bound printed matters, and cut-off processing for the bound printed matters.

### <Controller>

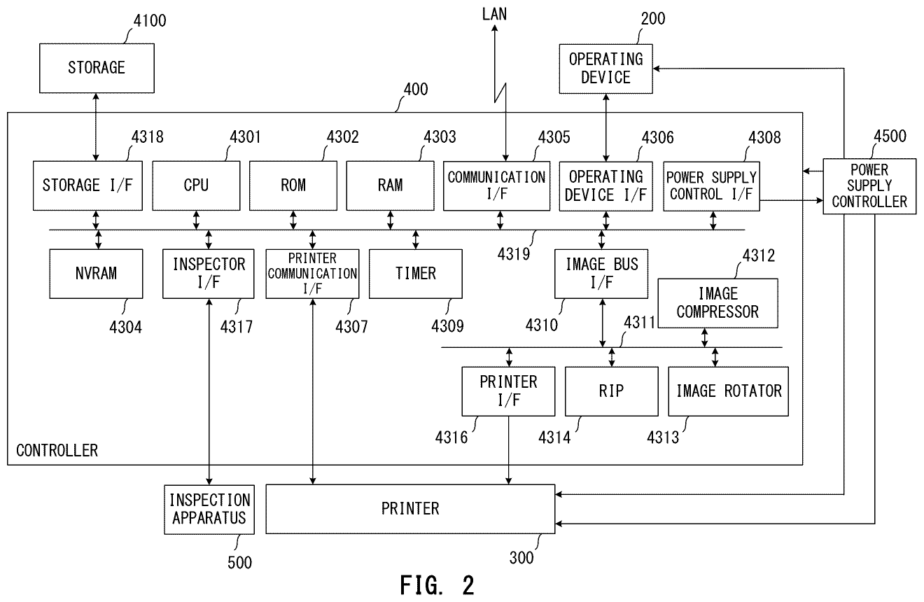

FIG. 2 is an explanatory diagram of a configuration of the controller 400. In addition to the printer 300, the inspection apparatus 500, and the operating device 200, the controller 400 is connected to a storage 4100 and a power supply controller 4500. The storage 4100 is a large-capacity storage device, such as a hard disk drive (HDD) or a solid state drive (SSD). As interfaces with the respective components to be connected, the controller 400 includes a storage I/F 4318, an operating device I/F 4306, a power supply control I/F 4308, an inspector I/F 4317, a printer communication I/F 4307, and a printer I/F 4316. The controller 400 also includes a communication I/F 4305 for communicating to/from an external apparatus through the network. The storage I/F 4318, the operating device I/F 4306, the power supply control I/F 4308, the inspector I/F 4317, the printer communication I/F 4307, and the communication I/F 4305 are connected to a system bus 4319.

The controller 400 includes a central processing unit (CPU) 4301, a read only memory (ROM) 4302, and a random access memory (RAM) 4303. The CPU 4301 executes a computer program stored in the ROM 4302 to control an operation of the image forming system 1. The RAM 4303 provides a work area for the CPU 4301 to execute processing. The RAM 4303 is also used as an image memory for temporarily storing image data and the like. The CPU 4301, the ROM 4302, and the RAM 4303 are also connected to the system bus 4319. A non-volatile RAM (NVRAM) 4304 and a timer 4309 are also connected to the system bus 4319. The NVRAM 4304 stores various parameters for control. The timer 4309 holds a current time, and monitors passage of a set time period.

The operating device I/F 4306 controls communication to/from the operating device 200. The operating device I/F 4306 receives input of print jobs, commands, and printing settings, which is performed from the operating device 200 to the controller 400, and transmits the input information to the CPU 4301. Under the control of the CPU 4301, the operating device I/F 4306 displays various screens and states of the image forming system 1 on a display of the operating device 200. Under the control of the CPU 4301, the printer communication I/F 4307 controls communication to/from the printer 300. The power supply control I/F 4308 instructs the power supply controller 4500 to supply or stop various kinds of electric power in accordance with a command received from the CPU 4301. The power supply controller 4500 supplies electric power to the printer 300. Under the control of the CPU 4301, the inspector I/F 4317 controls communication to/from the inspection apparatus 500. Under the control of the CPU 4301, the storage I/F 4318 controls communication to/from the storage 4100.

The communication I/F 4305 is connected to a network such as a local area network (LAN), and performs communication control, such as transmission and reception of an email and inputting and outputting of PDL data from an external apparatus. The communication I/F 4305 also includes an NVRAM (not shown), and holds various parameters relating to communication control, such as a MAC address.

The system bus 4319 is connected to an image bus 4311 through an image bus I/F 4310. The image bus I/F 4310 is a bridge that connects the system bus 4319 and an image bus 4311 for transferring image data to the printer 300 to each other. A printer I/F 4316, an image compressor 4312, an image rotator 4313, and a raster image processor (RIP) 4314 are connected to the image bus 4311.

The image compressor 4312 performs compression and decompression processing for JPEG, JBIG, MMR, MH, and the like. The image rotator 4313 performs image rotation processing. The RIP 4314 expands PDL code into a bitmap raster image. The printer I/F 4316 transmits image data to the printer 300. This image data is generated by the controller 400 subjecting image data for print output to image processing for the printer 300, such as correction for the printer 300 and resolution conversion.

### <Inspection Controller>

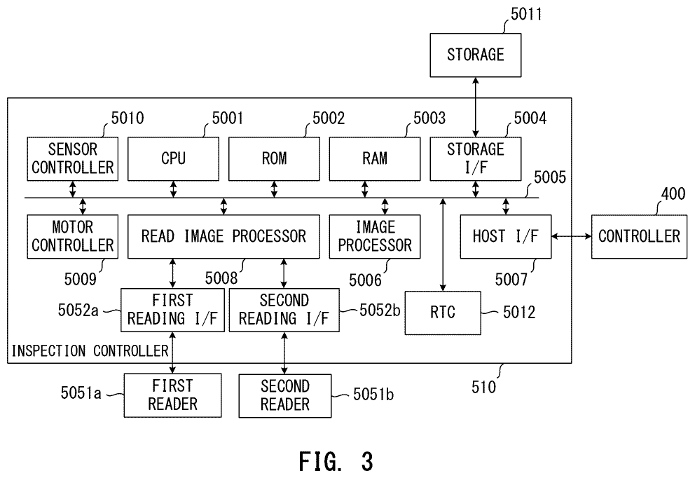

FIG. 3 is an explanatory diagram of a configuration of the inspection controller 510 provided to the inspection apparatus 500. The inspection controller 510 controls operations of the first reader 5051a and the second reader 5051b. The inspection controller 510 performs processing, such as analysis of the reading results from the first reader 5051a and the second reader 5051b, operation control of the inspection apparatus 500, and communication to/from the controller 400. The inspection controller 510 is also connected to a storage 5011, which is storage means for storing a misregistration correction profile and the like, and the controller 400.

The inspection controller 510 includes a CPU 5001, a ROM 5002, a RAM 5003, a storage I/F 5004, a motor controller 5009, a read image processor 5008, an image processor 5006, an RTC 5012, a host I/F 5007, and a sensor controller 5010. The respective components are connected to a system bus 5005. The read image processor 5008 is connected to the first reader 5051a through a first reading I/F 5052a, and is connected to the second reader 5051b through a second reading I/F 5052b. The RTC 5012 is a real-time clock, and holds the current time with high accuracy.

The host I/F 5007 controls communication to/from the inspector I/F 4317 of the controller 400. When the inspection controller 510 and the controller 400 communicate to/from each other, data is transmitted and received between the host I/F 5007 and the inspector I/F 4317. For example, the host I/F 5007 acquires image data used for an image forming operation of the printer 300 from the controller 400. The storage 5011 is a large-capacity storage device, such as an HDD or an SSD. The image data can be stored in any location, but is stored in the storage 5011 in the at least one embodiment.

The CPU 5001 executes a computer program stored in the ROM 5002 to control the operation of the inspection apparatus 500. The RAM 5003 provides a work area for the CPU 5001 to execute processing. The storage I/F 5004 controls communication to/from the storage 5011 connected to the inspection controller 510.

The read image processor 5008 is controlled by the CPU 5001 to acquire the reading result of the image on the printed matter from the first reader 5051a through the first reading I/F 5052a. The read image processor 5008 is also controlled by the CPU 5001 to acquire the reading result of the image on the printed matter from the second reader 5051b through the second reading I/F 5052b. Under the control of the CPU 5001, the read image processor 5008 performs magnification processing on the reading results (read data) of the images on the printed matter, which have been acquired from the first reader 5051a and the second reader 5051b, to generate read image data, and stores the read image data in the RAM 5003. The first reader 5051a and the second reader 5051b are each provided with a sensor array, and are each capable of reading an entire region of the printed matter conveyed on the conveying path 501. The first reader 5051a reads an image on a first side of a printed matter, and the second reader 5051b reads an image on a second side of the printed matter.

The first reader 5051a and the second reader 5051b are each formed of a light emitter and a light receiver. The light emitter is formed of, for example, a white light emitting diode (LED), and the light receiver is formed of, for example, a CMOS sensor equipped with an RGB color filter. The light emitter is controlled by the CPU 5001 to irradiate the printed matter being conveyed along the conveying path 501 with light. The light receiver receives the light reflected by the printed matter by separating the light into three color components of RGB through use of a color filter, and outputs read data as a light reception result (reading result). The read data is transmitted to the read image processor 5008.

Under the control of the CPU 5001, the motor controller 5009 controls operations of various motors provided in the inspection apparatus 500. Under the control of the CPU 5001, the sensor controller 5010 controls the operations of various sensors provided in the inspection apparatus 500, and notifies the CPU 5001 of detection results from the sensors. The image processor 5006 is controlled by the CPU 5001 to compare the image data stored in the storage 5011 (hereinafter referred to as “reference image data”) to the read image data stored in the RAM 5003, to thereby perform a quality inspection of the printed matter. The reference image data is image data to be used by the printer 300 forming an image, and is stored in the storage 5011. As another mode, the reference image data may be an image obtained by reading a reference image in advance before the quality inspection is performed. During the comparison, the image processor 5006 subjects the reference image data to correction processing using a parameter based on calibration described later.

### <Printing Settings>

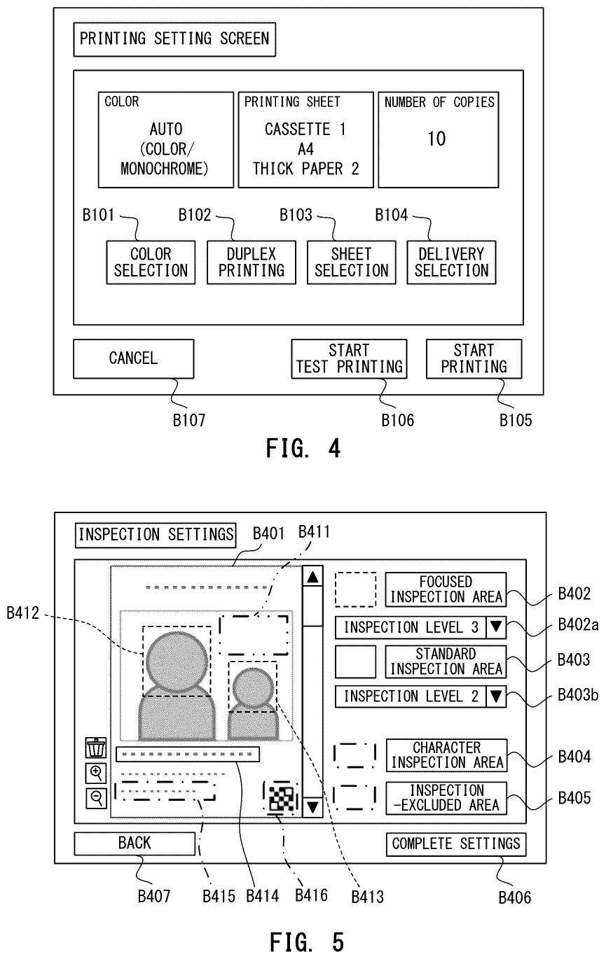

FIG. 4 is an explanatory view of an operation screen (printing setting screen) displayed on the display of the operating device 200 in order to instruct the printer 300 to perform printing. The operation screen functions as an information presentation screen for presenting information such as printing settings. This operation screen further functions as reception means for receiving an operation from the user such as printing start. A user causes the printer 300 to execute printing through use of such an operation screen displayed on the display. FIG. 4 indicates a state in which selection of color or monochrome is set to automatic selection, a cassette 1 is selected as a cassette for use, A4 is selected as a sheet size, thick paper 2 is selected as a type of paper, and 10 copies are selected as the number of copies to be printed.

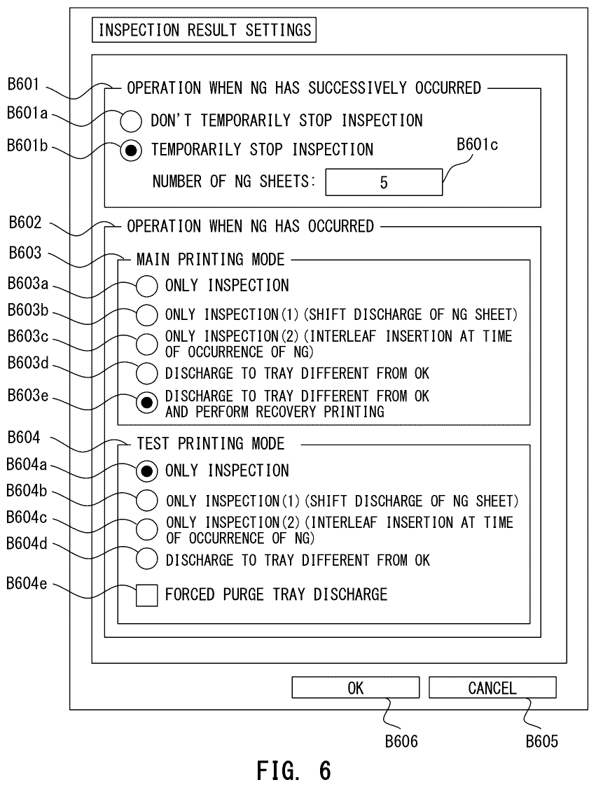

A button B101 to a button B104 are buttons for providing respective printing settings. The button B101 is a button for selecting the color (color or monochrome) for printing, and the button B102 is a button for selecting a printing side (simplex printing or duplex printing). The button B103 is a sheet selection button for selecting a type of sheet, and the button B104 is a delivery selection button for setting, for example, the discharge destination of the printed matter. When the button B104 is pressed by the user, the screen of the display transitions to an inspection result setting screen illustrated in FIG. 6. In addition, the number of copies to be printed can be set through use of a numeric keypad (not shown).

A button B105 is a printing start button which functions as first reception means, and when the button B105 is pressed, printing is started with the printing settings provided by the button B101 to the button B104 and the number of copies set by the numeric keypad, that is, main printing is started. A button B106 is a test printing start button which functions as second reception means, and when the button B106 is pressed, only one copy of the first page is printed with the printing settings provided by the button B101 to the button B104. A button B107 is a cancel button, and when the button B107 is pressed, the settings that have been input by the user are canceled, and an initial screen (not shown) is displayed on the display of the operating device 200.

Now, the test printing is described. When the test printing is executed under a state in which the print job has been received, while the received print job is kept stored so as to be printable, the same image as the image indicated by the print job can be printed on a sheet. When printing (main printing) that is not the test printing is executed under a state in which the print job has been received, after the image formation is performed based on the received print job, the print job is deleted. In this case, when an image indicated by the print job described above is desired to be printed again, it is required to receive the print job again.

For example, the test printing is a function of printing, instead of directly printing the number of a plurality of pages that become a printing target instructed through an operation screen, a designated part of the pages (for example, only one page) among the plurality of pages. Further, the test printing may be a function of, for example, printing fewer copies (for example, only one copy) than the number of a plurality of copies included in the print job that has been received in advance in order to check the printing result. As another example, the test printing may be a function of printing the number of pages or the number of copies different from the designated number of pages or the designated number of copies.

The image processor 5006 of the inspection apparatus 500 executes the inspection of the printed matter in accordance with inspection settings provided in advance. The central processing unit (CPU) 4301 of the controller 400 functions as control means. Irrespective of which of the button B105 and the button B106 is pressed, the CPU 4301 controls the printer 300 to print an image on a sheet, and controls the inspection apparatus 500 to execute the inspection of the printed matter in accordance with the inspection settings provided in advance. A button B107, which is a cancel button, is pressed, the settings that have been input by the user are canceled, and an initial screen (not shown) is displayed on the display of the operating device 200.

The printing setting screen illustrated in FIG. 4 may display, for example, a check box in a selectable manner. The check box is provided to select whether or not to execute an inspection. For example, the user (operator) touches the check box on the operation screen to place a checkmark in the check box or remove a checkmark from the check box. When the button B105 (or B106) is pressed under a state in which the checkmark is placed in the check box described above, the CPU 4301 controls the printer 300 to print an image on a sheet, and controls the inspection apparatus 500 to execute the inspection of the printed matter (image printed on the sheet). Meanwhile, when the button B105 (or B106) is pressed under a state in which no checkmark is placed in the check box described above, the CPU 4301 controls the printer 300 to print an image on a sheet without executing the inspection by the inspection apparatus 500.

### <Inspection Settings>

FIG. 5 is an explanatory view of an inspection setting screen for providing the inspection settings of the inspection apparatus 500. The inspection settings include a plurality of setting items which each affect the determination of whether or not the inspection result indicates an abnormality. Specifically, the inspection settings include a focused inspection area, a standard inspection area, a character/barcode inspection area, a QR code (trademark) inspection area, and an inspection-excluded area to be described later. The inspection setting screen has a function serving as reception means for receiving an instruction from the user for setting an inspection area in which an inspection such as a quality inspection is to be executed by the inspection apparatus 500. In FIG. 5, an area B401 is a printed-image and inspection-setting-area display portion, and the inspection area can be freely set through use of a mouse, a touch panel, or the like. In this example, an original image in a print job is displayed in the area B401, and an area B411 to an area B416 are illustrated as inspection areas. The area B401 and the area B411 to the area B416 are each a rectangular region, but any shape, such as a triangle, a polygon, or a circle, may be able to be designated in accordance with a shape of an area to be inspected.

A button B402 to a button B405 are buttons for setting an inspection area type. The user can set the inspection area by setting a region in the area B401 with one of the button B402 to the button B405 being selected. In FIG. 5, four types of buttons are illustrated for setting the inspection area type. The button B402 is a focused inspection area setting button for setting an area in which a highly accurate inspection is to be performed, and the button B403 is a standard inspection area button for setting an overall inspection level. In addition, the button B404 is a detailed setting button for providing detailed settings regarding a variable inspection area that is an area in which a variable inspection is to be performed. The variable inspection area is an area within the entire print image in which data that is variable for each page, each copy, or each sheet is embedded, and, for example, a number, a barcode, or the like that differs for each sheet is formed in the variable inspection area. It can be determined whether or not there is an abnormality in the image based on whether or not the information indicated by a reading result of the variable inspection area has consistency that follows a predetermined rule, for example, an ascending order or a descending order of numbers. The example of FIG. 5 shows a state in which a character inspection area has been selected as the variable inspection area. Further, in the example of FIG. 5, the character inspection area is an area for inspecting not only a character string but also a two-dimensional code and a barcode. The button B405 is an inspection-excluded area button for designating an area in which an inspection is not to be performed.

In the example of FIG. 5, an inspection level setting button for setting an inspection level in terms of inspection accuracy stepwise, for example, from a level 1 to a level 5, may be provided for each inspection area. Specifically, a button B402a is provided as an inspection level setting button for the button B402 that is the focused inspection area, and a button B403b is provided as an inspection level setting button for the button B403 that is the standard inspection area. This allows the user to set the inspection level for each of the focused inspection area of the button B402 and the standard inspection area of the button B403. In the example of FIG. 5, an inspection level 1 has the lowest inspection accuracy, and the inspection accuracy increases as an inspection level number increases. In FIG. 5, an inspection level 3 is set as the inspection level for the focused inspection area, and an inspection level 2 is set as the inspection level for the standard inspection area.

A button B406 is an inspection start button, and when the user selects and presses this button, the inspection is started. A button B407 is a button for returning to the previous screen, and when the user selects this button, inspection setting processing is canceled to return to an initial screen (not shown). In addition, a dotted-line rectangle is shown on the left side of the button B402 representing the focused inspection area, and it is visually shown that the focused inspection area is represented by a dotted-line rectangle within the area B401. In the same manner, a solid-line rectangle is shown on the left side of the button B403 representing the standard inspection area, and the standard inspection area is represented by a solid-line rectangle within the area B401. A one-dot-chain-line rectangle is shown on the left side of the button B404 representing the character inspection area, and the character inspection area is represented by a one-dot-chain-line rectangle within the area B401. A two-dot-chain-line rectangle is shown on the left side of the button B405 representing an inspection-excluded area, and an inspection-excluded area is represented by a two-dot-chain-line rectangle within the area B401.

For example, the user can freely select an area to be subjected to a focused inspection by selecting the button B402 and selecting, through use of a mouse or the like, an area within the area B401 in which a focused inspection is required to be performed. In the example of FIG. 5, the areas B412 and B413, which are areas including human faces, are both represented by dotted-line rectangles, and those areas are shown as the focused inspection areas set by the button B402. The area B414 is represented by a solid-line rectangle, and is shown as the standard inspection area set by the button B403. The area B415 and the area B416 are both represented by one-dot-chain-line rectangles, and are shown as the character inspection areas for inspecting a character string, a two-dimensional code, and a barcode which are set by the button B404. In the example of FIG. 5, the area B415 is an area including a character string, and the area B416 is an area including a two-dimensional code. The area B411, which is a background region and is not required to be subjected to a highly accurate inspection, is represented by a two-dot-chain-line rectangle, and is shown as the inspection-excluded area set by the button B405.

Compared to a case of inspecting an entire image, only required areas can be selected to be inspected, to thereby be able to reduce resources required for the inspection, for example, a use amount of the RAM 5003 of the inspection apparatus 500 and a load and throughput for processing performed on the CPU 5001. In addition, through setting of the inspection level stepwise, for example, from the level 1 to the level 5, resources of an image forming apparatus required for the inspection can be reduced compared to a case of constantly performing the inspection at a high level of inspection accuracy. Further, through setting of a plurality of areas and setting of the inspection level for each of the areas, the resources can be optimally allocated in accordance with the required level of inspection accuracy.

### <Printing Inspection During Test Printing>

The test printing is used for checking whether or not the print image, the printing settings of the printer 300, and the inspection settings of the inspection apparatus 500 are correct.

For example, when a print image includes a character string and the user wishes to inspect whether or not the printed character string is correct through use of the inspection apparatus 500, the user sets a character string area by the above-mentioned method. The inspection apparatus 500 performs optical character recognition (OCR) processing on the print image in the set area. However, when the setting of the area set by the user is incorrect, an inspection result is abnormal or unacceptable (NG). Examples thereof include a case in which an area other than a character string is set as the inspection area for a character string and a case in which a part of a character string is not included in the area set by the user. In the following description, the fact that an inspection result or the like is abnormal or unacceptable is simply referred to as “inspection NG” or the like.

Further, when the inspection level set by the user is different from the inspection accuracy intended by the user, “inspection NG” may be determined even within a range that is considered to be acceptable by the user. When, for example, the set inspection level is stricter than the inspection accuracy intended by the user, “inspection NG” may be determined against such an intention of the user. When the main printing is executed under such a state as described above, there is a possibility that the number of sheets that are determined as “inspection NG” may increase. In addition, in a case in which the inspection result is unacceptable in the main printing and recovery printing is executed, when there is a setting error, a situation in which the inspection result is unacceptable occurs repeatedly, which leads to wasteful paper consumption and increasing apparatus downtime. At the time of execution of the test printing, recovery printing is not executed even when the inspection result is unacceptable, and the inspection apparatus 500 notifies, through the operating device 200, the user whether or not there is an error in the inspection settings.

### <Inspection Result Settings>

FIG. 6 is an explanatory view of an inspection result setting screen for performing inspection result settings of the inspection apparatus 500. This inspection result setting screen has a function as reception means for receiving, when an inspection is executed by the inspection apparatus 500, an instruction from a user for setting a recovery printing operation to be performed when inspection NG has occurred as a result of inspection determination, or a sheet processing method (such as a discharge operation of the NG sheet). In FIG. 6, a group B601 relates to settings of an operation in a case in which inspection NG has successively occurred, and includes radio buttons B601a and B601b and an input field B601c for inputting the number of inspection NG sheets. The radio button B601a is used to set “Don't temporarily stop inspection,” and the radio button B601b is used to set “Temporarily stop inspection.” As described above, in the group B601, whether to continue or stop printing when inspection NG has been detected as a result of performing an inspection by the inspection apparatus 500 can be set. Specifically, when the radio button B601a is selected, even when the inspection NG is detected, the setting for executing the print job to the end without stopping the printing is provided. Further, when the radio button B601b is selected, the setting for temporarily stopping the printing operation when the inspection NG is successively detected on the number of printed sheets corresponding to the setting value input by the user in the input field B601c is provided. In the example of the illustrated group B601, the setting for temporarily stopping the inspection and the printing when the inspection NG sheet has been successively detected five times in the inspection results during the printing is provided.

Now, the function for setting the discharge destination is described. In the main printing, it is desired to discharge a sheet (NG sheet) having an inspection result indicating that there is an abnormality and a sheet (OK sheet) having an inspection result indicating that there is no abnormality to different trays. The reason therefor is because, when both of the OK sheet and the NG sheet are discharged to the same delivery tray in the main printing, it takes time and effort to remove the NG sheet. However, there are exceptions. For example, in order to facilitate movement to the next step of a sheet (printed product) on which an image has been formed in the main printing, in some cases, both of the OK sheet and the NG sheet may be discharged to the same tray.

Meanwhile, also in the test printing, various needs are conceivable. For example, when the user (operator) desires to execute the test printing in order to check the printing result, the user (operator) is required to take out the sheet on which the image has been printed from the tray. In this case, when the sheets are discharged to the same tray in both of the case (NG sheet) in which the inspection result of the image printed on the sheet in the test printing indicates that there is an abnormality and the case (OK sheet) in which the inspection result indicates that there is no abnormality, the user can easily take out the sheet (printed product). Meanwhile, for example, when the test printing is executed as a final check immediately before the main printing, unless the NG sheet occurs, it is desired to treat the sheet on which the image has been printed in the test printing as a sheet (OK sheet) having an inspection result indicating that there is no abnormality in the main printing. In this case, the sheet on which the image has been printed in the test printing is discharged to the tray to which the sheet is to be discharged in the main printing.

At the time of the test printing, in some cases, a desired discharge setting (delivery tray) may vary. However, in the related-art image forming system, the discharge setting (delivery tray) at the time of NG determination has been unswitchable between the test printing and the main printing. In view of the above, in the following, a method of setting the discharge destination individually for the test printing and the main printing is described.

A group B602 is an item for providing settings of an operation (printed sheet discharge control) to be performed when the inspection NG has been detected, and includes sub-groups B603 and B604. The sub-group B603 relates to settings of discharge control in a main printing mode. The sub-group B604 relates to settings of an operation in a test printing mode. The sub-group B603 includes radio buttons B603a to B603e, and predetermined discharge control can be set by selecting any one of the radio buttons.

The radio button B603a is used to set “Only inspection.” When the radio button B603a is selected, regardless of the inspection result, all of the sheets discharged from the printer 300 are discharged to the same tray (large-capacity tray 610). This case means that, when the inspection NG has been detected, the NG sheet is discharged to the same tray as the large-capacity tray 610 to which the OK sheet (sheet determined as not having inspection NG as a result of the inspection determination (determined as being OK)) is to be discharged.

The radio button B603b is used to set “Only inspection (1) (Shift discharge of NG sheet).” When the radio button B603b is selected, regardless of the inspection result, all of the sheets discharged from the printer 300 are discharged to the same tray. In this case, when the inspection NG has been detected, the NG sheet is discharged to the same tray as the tray to which the OK sheet is to be discharged. However, the NG sheet is discharged in a manner of being shifted in a predetermined direction with respect to the OK sheet. In this manner, discharge control that allows the OK sheet and the NG sheet to be easily discriminated is performed.

The radio button B603c is used to set “Only inspection (2) (Interleaf insertion at time of occurrence of inspection NG).” When the radio button B603c is selected, regardless of the inspection result, all of the sheets discharged from the printer 300 are discharged to the same tray. In this case, when the inspection NG has been detected, the NG sheet is discharged to the same tray as the tray to which the OK sheet is to be discharged. However, an interleaf is inserted after predetermined pages of the NG sheet. In this manner, discharge control that allows the operator to easily discriminate the NG sheet is performed. The interleaf is inserted after the sheet for which the image formation is in execution by the printer. Therefore, the position to insert the interleaf varies depending on the type of the image forming apparatus or the sheet and the printing settings. For example, when the sheet size and the printing mode are “plain paper, A3 size sheet, and simplex printing,” the position to insert the interleaf is set to four pages after the NG sheet.

The radio button B603d is used to set “Discharge to tray different from OK.” When the radio button B603d is selected, the discharge destination of the sheet on which the image has been printed is switched in accordance with the inspection result. Accordingly, the NG sheet is discharged to a tray (for example, the purge tray 620) different from the tray to which the OK sheet is to be discharged. In this manner, discharge control of discriminating the OK sheet and the NG sheet with the delivery trays is performed.

The radio button B603e is used to set “Discharge to tray different from OK and perform recovery printing.” When the radio button B603e is selected, the discharge destination of the sheet on which the image has been printed is switched in accordance with the inspection result, and the printing is restarted from the image whose inspection result is determined as NG. The NG sheet is discharged to a tray (for example, the purge tray 620) different from the tray to which the OK sheet is to be discharged, and control of automatically re-printing the NG sheet is performed. Specifically, in a case of a printed product formed of a plurality of pages, when the inspection result is determined as NG in the middle of execution of the printing, all of sheets positioned on the upstream back in a sheet conveyance path from the NG sheet are discharged to the purge tray 620. After that, the printer 300 automatically performs re-printing from the printing position of the NG sheet. In this manner, on the tray to which the OK sheet is to be discharged, sheets that are all OK are stacked in a page order determined in advance. This processing is called recovery printing processing.

As described above, the discharge control in the main printing is set by the user selecting one button among the radio buttons B603a to B603e. Further, in addition to a discharge destination setting such as discharge of the NG sheet to the purge tray 620 different from the case of the OK sheet, the setting of the processing after the inspection, for example, the setting of the shift discharge of the NG sheet, interleaf insertion at the time of occurrence of the inspection NG, recovery printing, and the like can be performed.

The sub-group B604 relates to settings of discharge control in the test printing mode. The sub-group B604 includes radio buttons B604a to B604d and a check box B604e. The discharge control in the test printing mode is set by selecting one button among the radio buttons B604a to B604d, and the discharge destination in the selected setting is changed depending on whether or not the check box B604e is checked. The same operations as the radio buttons B603a to B603d are set for the respective radio buttons B604a to B604d, and hence description of the radio buttons B604a to B604d is omitted.

The check box B604e is used to perform a forced discharge destination setting, and, in this example, is used to set “Forced purge tray discharge.” When the check box B604e is selected (a check is set therein), only the discharge destination is forcibly changed. In this example, when the check box B604e is checked, both of the OK sheet and the NG sheet are all forcibly discharged to the purge tray 620. In this case, the purge tray 620 functions as a forced-discharge tray. For example, when a check is set in the check box B604e under a state in which the radio button B604d is selected, priority is given to the setting of the check box B604e, and the setting of the radio button B604d of discharging the OK sheet and the NG sheet to different trays become invalid. Further, the same holds true also for the radio buttons B604a to B604c. Therefore, when a check is set in the check box B604e, the setting of the discharge destinations for the OK sheet and the NG sheet in the radio button B604a to the radio button B604d become invalid, and priority is given to the setting of the check box B604e.

A button B605 is an OK button, and, when the user presses this button B605, the inspection result settings provided in the inspection result setting screen are stored. A button B606 is a button for canceling the inspection result settings provided in the inspection result setting screen. When the user presses this button B606, the items of the inspection result settings are canceled, and the screen of the display returns to the printing setting screen (FIG. 4).

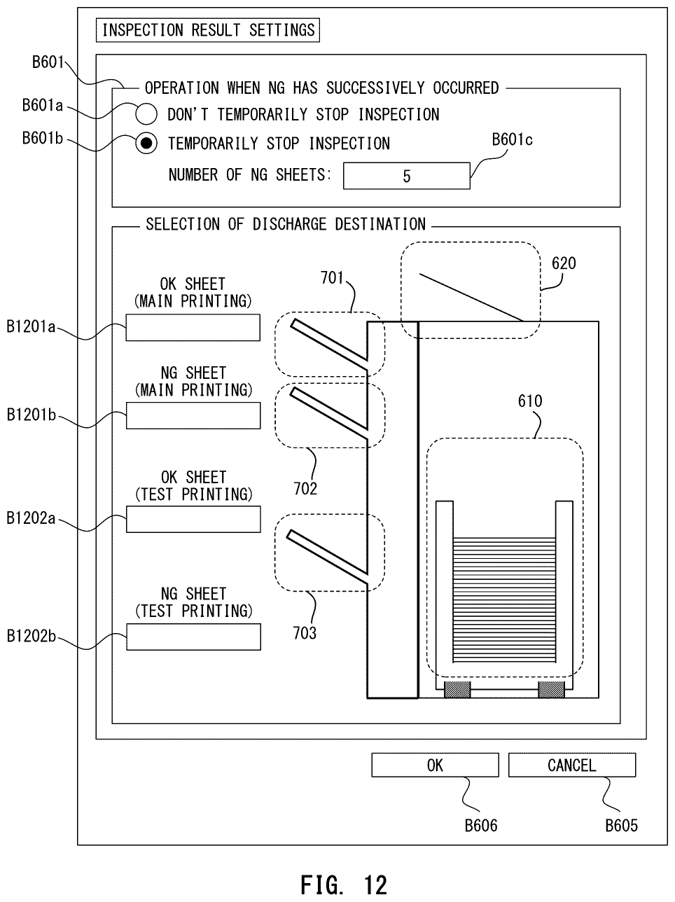

Further, the inspection result setting screen to be displayed on the display of the operating device 200 may have a configuration illustrated in FIG. 11. In the inspection result setting screen illustrated in FIG. 11, the group B601, the radio button B601a, the radio button B601b, the input field B601c, the button B605, and the button B606 have been described with reference to FIG. 6, and hence description thereof is omitted.

A sub-group B1110 includes pull-down buttons B1111a and B1111b for use in selecting the discharge destination of the sheet on which the image has been formed. When the user presses the pull-down button B1111a in the inspection result setting screen, the tray to which the sheet (OK sheet) that is not determined as inspection NG in the main printing is to be discharged can be selected from a plurality of delivery trays. Further, when the user presses the pull-down button B1111b in the inspection result setting screen, the tray to which the sheet (NG sheet) that is determined as inspection NG in the main printing is to be discharged can be selected from a plurality of delivery trays. In this case, the plurality of delivery trays are the large-capacity tray 610, the purge tray 620, the delivery tray 701, the delivery tray 702, and the delivery tray 703 illustrated in FIG. 1. The user can also set the discharge destination so that, for example, the OK sheet and the NG sheet are discharged to the same tray in the main printing.

A sub-group B1120 includes pull-down buttons B1121a and B1121b for use in selecting the discharge destination of the sheet on which the image has been formed. When the user presses the pull-down button B1121a in the inspection result setting screen, the tray to which the sheet (OK sheet) that is not determined as inspection NG in the test printing is to be discharged can be selected from a plurality of delivery trays. Further, when the user presses the pull-down button B1121b in the inspection result setting screen, the tray to which the sheet (NG sheet) that is determined as inspection NG in the test printing is to be discharged can be selected from a plurality of delivery trays. In this case, the plurality of delivery trays are the large-capacity tray 610, the purge tray 620, the delivery tray 701, the delivery tray 702, and the delivery tray 703 illustrated in FIG. 1. The user can also set the discharge destination so that, for example, the OK sheet and the NG sheet are discharged to the same tray in the test printing.

Further, the inspection result setting screen to be displayed on the display of the operating device 200 may have a configuration illustrated in FIG. 12. In the inspection result setting screen illustrated in FIG. 12, the group B601, the radio button B601a, the radio button B601b, the input field B601c, the button B605, and the button B606 have been described with reference to FIG. 6, and hence description thereof is omitted.

In the inspection result setting screen illustrated in FIG. 12, a window for setting the discharge destination is displayed. Inside of the window, images corresponding to a plurality of discharge destinations and a plurality of input fields B1201a, B1201b, B1202a, and B1202b are shown. Further, in FIG. 12, the large-capacity tray 610, the purge tray 620, the delivery tray 701, the delivery tray 702, and the delivery tray 703 are also shown. The input field B1201a is a button for selecting the tray to which the sheet (OK sheet) that is not determined as inspection NG in the main printing is to be discharged. The input field B1201b is a button for selecting the tray to which the sheet (NG sheet) that is determined as inspection NG in the main printing is to be discharged. The input field B1202a is a button for selecting the tray to which the sheet (OK sheet) that is not determined as inspection NG in the test printing is to be discharged. The input field B1202b is a button for selecting the tray to which the sheet (NG sheet) that is determined as inspection NG in the test printing is to be discharged. When the user touches the input field B1201a and then touches any discharge destination on the image showing a plurality of discharge destinations, the discharge destination that is finally touched is input to the input field B1201a. For example, any discharge destination can be input by touching the image of the large-capacity tray 610, the purge tray 620, the delivery tray 701, the delivery tray 702, or the delivery tray 703 in FIG. 12. The same holds true also for the other input fields B1201b, B1202a, and B1202b.

### <Test Printing Inspection Processing Flow>

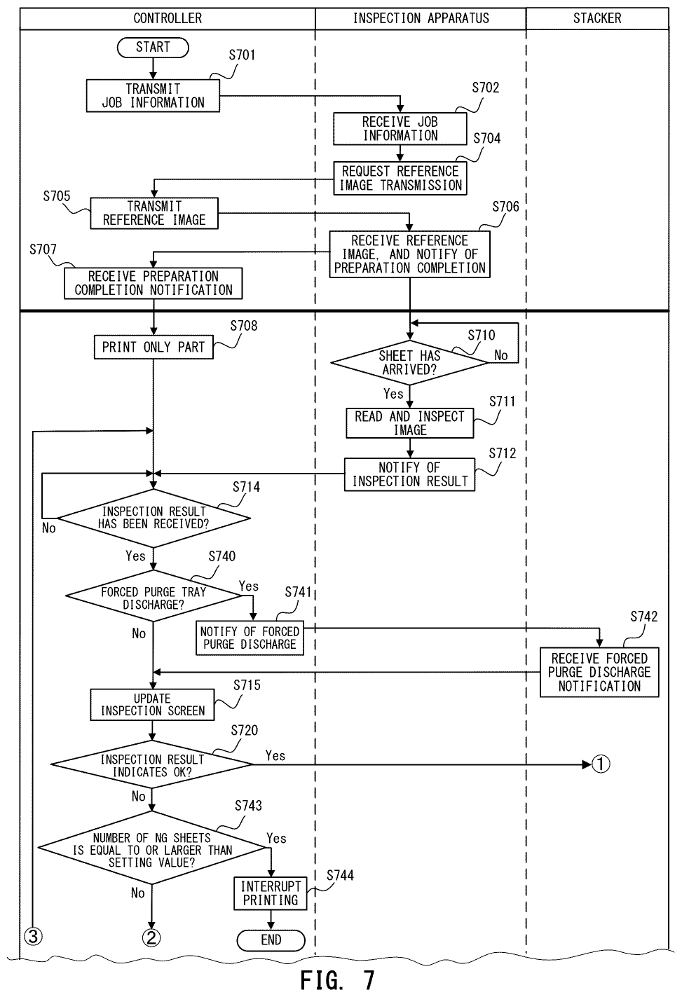

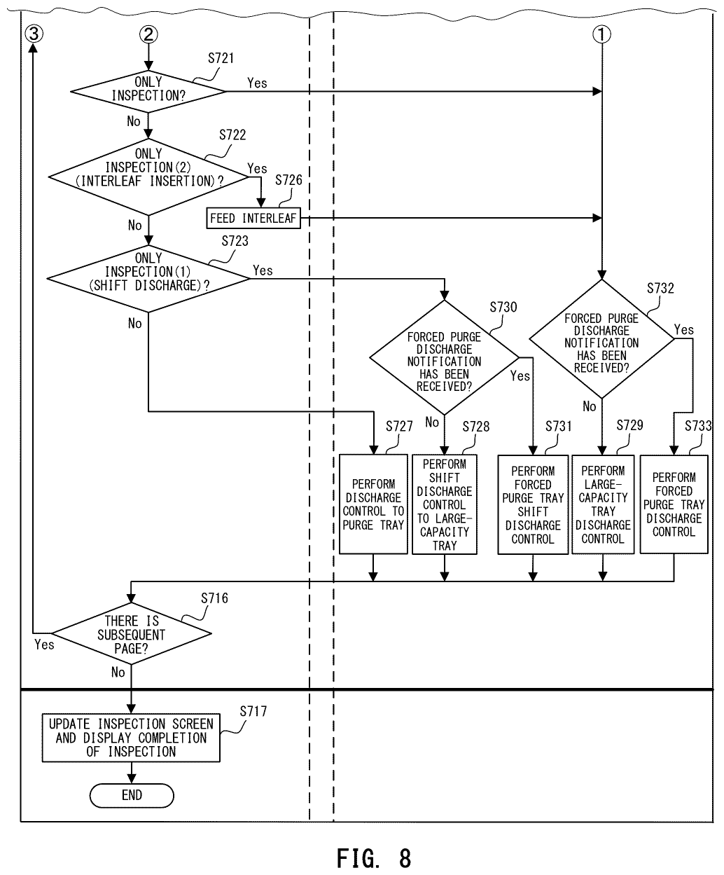

FIG. 7 and FIG. 8 are flow charts of test printing inspection processing. The test printing is a processing process to be executed in order to check whether or not the print image, the printing settings of the printer 300, and the inspection settings of the inspection apparatus 500 are correct. In this flow chart, processing to be executed by the CPU 4301 of the controller 400 and processing to be executed by the CPU 5001 of the inspection apparatus 500 are collectively illustrated. In FIG. 4, when the user presses the test printing start button (button B106), the CPU 4301 of the controller 400 is instructed to execute the test printing, and the test printing is executed in accordance with the instruction.

When the user selects the button B106 through the operating device 200, the CPU 4301 of the controller 400 transmits, to the inspection apparatus 500, job information including, for example, sheet information for use in printing, inspection settings, and a discharge destination as a result of the inspection result (Step S701). The CPU 5001 of the inspection apparatus 500 receives the job information from the controller 400 (Step S702). After having received the job information from the controller 400, the CPU 5001 of the inspection apparatus 500 transmits, to the controller 400, a reference image transmission request for inspection determination (Step S704).

The CPU 4301 of the controller 400 transmits original image data of the print job as reference image data to the inspection apparatus 500 based on the reference image transmission request received from the inspection apparatus 500 (Step S705). The CPU 5001 of the inspection apparatus 500 receives the reference image from the controller 400 to store the reference image in the storage 5011, and notifies the controller 400 of completion of preparation for the print job (Step S706).

When the CPU 4301 of the controller 400 receives a preparation completion notification from the inspection apparatus 500 (Step S707), the CPU 4301 controls the printer 300 to start the printing only for a part (Step S708). After the execution of Step S706, the CPU 5001 of the inspection apparatus 500 determines whether or not a sheet has arrived at a sheet detection position of the sheet detection sensor 504 on the conveying path 501 of the inspection apparatus 500 (Step S710). When a sheet has not arrived (No in Step S710), the CPU 5001 of the inspection apparatus 500 waits for a sheet to arrive. When a sheet has arrived (Yes in Step S710), the CPU 5001 of the inspection apparatus 500 reads the sent sheet by the first reader 5051a and the second reader 5051b, and instructs the image processor 5006 to perform processing for comparison to the reference image data received in Step S706. Accordingly, the image processor 5006 performs the processing for comparison to perform an image inspection (Step S711). After that, the CPU 5001 of the inspection apparatus 500 transmits the inspection result of the image inspection based on the comparison performed by the image processor 5006 to the controller 400 (Step S712).

The CPU 4301 of the controller 400 determines whether or not the inspection result has been received (Step S714). When the inspection result has not been received (No in Step S714), the CPU 4301 waits for reception of the inspection result, and when the inspection result has been received (Yes in Step S714), the CPU 4301 determines whether or not the forced purge tray discharge has been set. Specifically, it is determined whether or not a check is set in the check box B604e in the inspection result setting screen of FIG. 6. When the forced purge tray discharge has been set (Yes in Step S740), the CPU 4301 of the controller 400 notifies the stacker 600 of the forced purge discharge notification (Step S741). The stacker 600 receives this forced purge discharge notification (Step S742).

When the forced purge tray discharge has not been set (No in Step S740), the CPU 4301 of the controller 400 controls the operating device 200 to update the inspection screen (not shown) based on the inspection result (Step S715). The inspection screen is a screen for displaying, for example, items such as a positional misalignment and a stain of an inspection target image, and is displayed on the display provided in the operating device 200. Further, the update of the inspection screen means changing those items based on the inspection result. Next, the CPU 4301 of the controller 400 determines whether or not the inspection result indicates OK (Step S720). When the inspection result is OK determination (Yes in Step S720), the process proceeds to Step S732.

The discharge destination of the sheet is determined by the delivery tray selected by the button B104 that is the delivery selection button of the printing setting screen of FIG. 4 and the discharge control set in the inspection result setting screen of FIG. 6. As an example of the setting, in the at least one embodiment, the delivery tray is set to the large-capacity tray 610 by the button B104 in the printing setting screen of FIG. 4, and the inspection result settings are as illustrated in FIG. 6. In this case, the radio button B604a is selected in the sub-group B604 in FIG. 6. Accordingly, when the inspection result of the inspection apparatus 500 is OK determination (Yes in Step S720), as long as the forced purge discharge notification has not been received (No in Step S732), large-capacity tray discharge control that uses the large-capacity tray as the discharge destination is executed (Step S729). Details of Step S732 and Step S729 are described later.

Meanwhile, when the inspection result is NG determination (No in Step S720), the CPU 4301 of the controller 400 determines whether or not the number of NG sheets detected successively from the start of the test printing is equal to or larger than a setting value input by the user through the input field B601c (Step S743). When the number is equal to or larger than the setting value (Yes in Step S743), the CPU 4301 of the controller 400 executes interruption of the printing (Step S744), and ends the processing. When the number is not equal to or larger than the setting value (No in Step S743), the CPU 4301 of the controller 400 determines whether or not the radio button B604a is selected, that is, “Only inspection” is selected (Step S721). When “Only inspection” is selected (Yes in Step S721), the process proceeds to Step S732.

When “Only inspection” is not selected (No in Step S721), the CPU 4301 of the controller 400 determines whether or not the radio button B604c is selected, that is, “Only inspection (2) (Interleaf insertion)” is selected (Step S722). When “Only inspection (2) (Interleaf insertion)” is selected (Yes in Step S722), the CPU 4301 of the controller 400 feeds an interleaf (Step S726), and the process proceeds to Step S732. When “Only inspection (2) (Interleaf insertion)” is not selected (No in Step S722), the CPU 4301 of the controller 400 determines whether or not the radio button B604b is selected, that is, “Only inspection (1) (Shift discharge)” is selected (Step S723).

When “Only inspection (1) (Shift discharge)” is selected (Yes in Step S723), the process proceeds to Step S730. When “Only inspection (1) (Shift discharge)” is not selected (No in Step S723), the CPU 4301 of the controller 400 instructs the stacker 600 to perform the discharge control to the purge tray (Step S727). The determinations in Step S721, Step S722, and Step S723 are made by the CPU 4301 of the controller 400 referring to the setting items in the sub-group B604 of FIG. 6.

Further, when the determination result of Step S723 is No, the discharge control to the purge tray is performed without determining whether or not the forced purge discharge notification has been received. This state in which the determination result of Step S723 is No means that the radio button B603d is selected without selecting the radio buttons B604a to B604c in the sub-group of FIG. 6. In this case, the NG sheet is discharged to the purge tray regardless of whether or not the check box is checked in the radio button B603e. Therefore, the processing step of determining whether or not the forced purge discharge notification has been received in FIG. 6 is omitted. For the OK sheet, in Step S722, when the check box is checked in the radio button B603e, the forced purge tray discharge control is performed. Therefore, in the example of FIG. 6, even when the radio button B603d is selected and the check box is checked in the radio button B603e, both of the NG sheet and the OK sheet are discharged to the forced purge tray.

In Step S730, the CPU 4301 of the controller 400 determines whether or not the stacker 600 has received the forced purge discharge notification. When the forced purge discharge notification has not been received (No in Step S730), the CPU 4301 of the controller 400 determines the large-capacity tray as the discharge destination in the stacker 600, and performs large-capacity tray shift discharge control (Step S728). In the large-capacity tray shift discharge control, the shift discharge is performed in the large-capacity tray. When the forced purge discharge notification has been received (Yes in Step S730), the CPU 4301 of the controller 400 determines the forced purge tray as the discharge destination in the stacker 600 and performs forced purge tray shift discharge control (Step S731). In the forced purge tray shift discharge control, the shift discharge is performed in the forced purge tray. After Step S728 and Step S731, the process proceeds to Step S716.

In Step S732, the CPU 4301 of the controller 400 determines whether or not the stacker 600 has received the forced purge discharge notification. When the forced purge discharge notification has not been received (No in Step S732), the CPU 4301 of the controller 400 determines the large-capacity tray as the discharge destination in the stacker 600, and performs large-capacity tray discharge control (Step S729). When the forced purge discharge notification has been received (Yes in Step S732), the CPU 4301 of the controller 400 determines the forced purge tray as the discharge destination in the stacker 600 and performs forced purge tray discharge control (Step S733). After Step S729 and Step S733, the process proceeds to Step S716.

After that, the CPU 4301 of the controller 400 determines whether or not there is a subsequent page (Step S716). When there is a subsequent page (Yes in Step S716), the process returns to Step S714. When there is no subsequent page (No in Step S716), the CPU 4301 of the controller 400 controls the operating device 200 to update the inspection screen so that completion of the inspection is displayed (Step S717), and ends the processing (test printing inspection processing).

As described above, when the check box B604e is selected in the sub-group B604 (Yes in Step S740), the forced purge discharge notification is given to the stacker 600 (Step S741). In the stacker 600, when the forced purge discharge notification has been received (Step S742), regardless of the settings of the radio buttons B604a, B604b, and B604c, the discharge control in which the delivery tray is always set to the purge tray 620 is performed (Step S727, Step S731, and Step S733).

In the example of FIG. 6, as illustrated in FIG. 6, the radio buttons and the input field are set as shown in the group B601 and the sub-group B604. Therefore, when it is determined that the number of NG sheets has reached five sheets in Step S743 (Yes in Step S743), the printing is interrupted (Step S744). Meanwhile, when the number of NG sheets has not reached five (No in Step S743), because “Only inspection” is designated by the radio button B604a, the determination result of Step S721 becomes Yes, and the process advances to Step S732. The check box B604e is not checked (No in Step S732), and hence the large-capacity tray discharge control is executed (Step S729).

As another example, when the radio button B604c of the sub-group B604, that is, “Only inspection (2) (Interleaf insertion)” is selected, the determination result of Step S721 is No and the determination result of Step S722 is Yes. Therefore, processing of feeding an interleaf (Step S726) is executed after the determinations are made. After that, the process advances to Step S732. When the check box B604e is not checked (No in Step S732), the large-capacity tray discharge control is executed (Step S729). When the check box B604e is checked (Yes in Step S732), the forced purge tray discharge control is executed (Step S733).

As further another example, when “Only inspection (1) (Shift discharge of NG sheet)” is selected by the radio button B604b, the determination result of Step S723 becomes Yes, and the process advances to Step S730. When the forced purge discharge notification has not been received (No in Step S730), the large-capacity tray shift discharge control (Step S728) is executed. When the forced purge discharge notification has been received (Yes in Step S730), the forced purge tray shift discharge control is executed (Step S731).

In the example of FIG. 6, when the check box B604e is checked, the sheet is forcibly discharged to the purge tray. For example, when the printed sheet is taken out from the tray in order to check the printing result, processing is easier when both of the OK sheet and the NG sheet are discharged to the same tray, and hence such forced discharge is suitable. The forced discharge destination is not limited to the purge tray, and may be other trays. The discharge destination may be the large-capacity tray, or, when there are discharge destinations other than the purge tray and the large-capacity tray, one of the other discharge destinations may be set as the forced discharge destination. The reason therefor is because, even in this case, both of the OK sheet and the NG sheet are discharged to the same tray.

### <Main Printing Inspection Processing Flow>

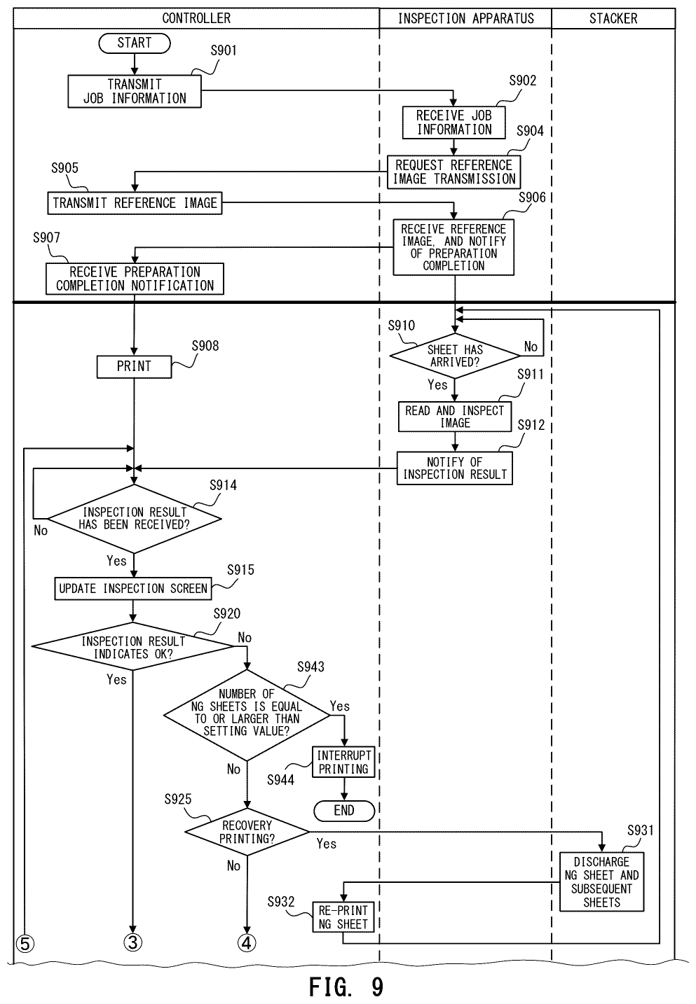

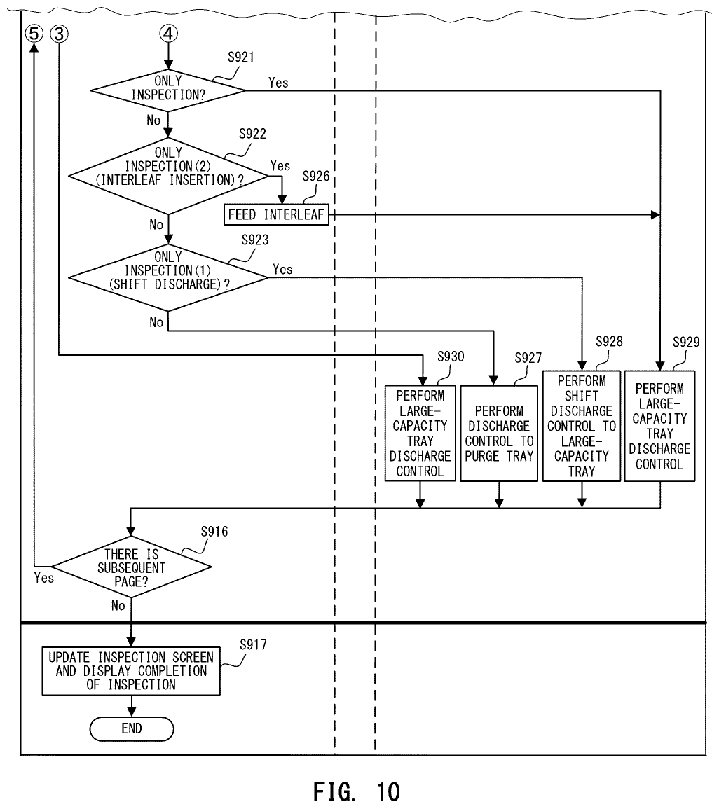

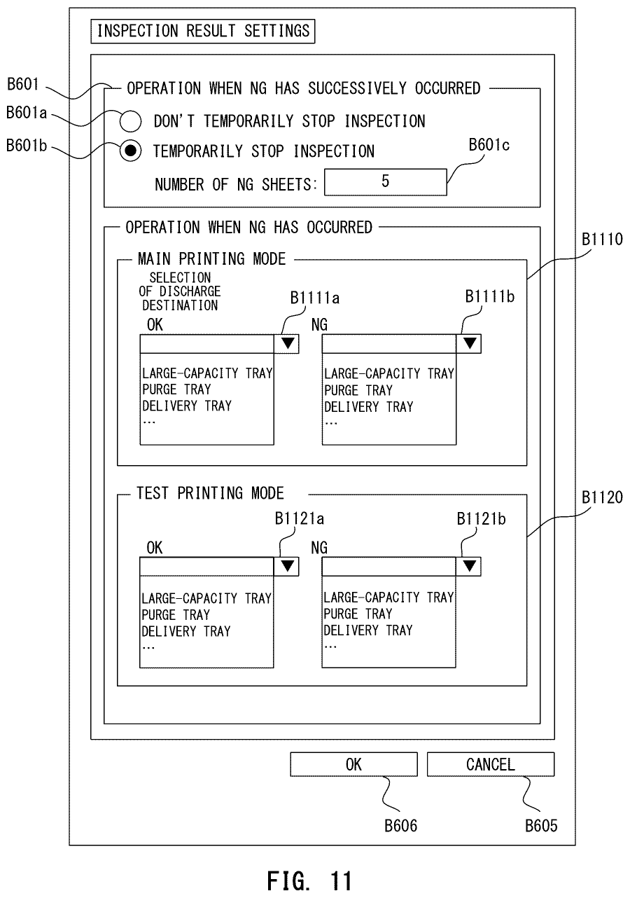

FIG. 9 and FIG. 10 are flow charts of main printing inspection printing processing. In those flow charts, processing to be executed by the CPU 4301 of the controller 400 and processing to be executed by the CPU 5001 of the inspection apparatus 500 are collectively illustrated. In FIG. 4, when the user selects and presses the button B105, the CPU 4301 of the controller 400 is instructed to execute the inspection printing, and the inspection printing is executed in accordance with the instruction.

When the button B105 is selected through the operating device 200, the CPU 4301 of the controller 400 transmits, to the inspection apparatus 500, job information including, for example, sheet information for use in printing, inspection items, and a discharge destination indicated by the inspection result (Step S901). The CPU 5001 of the inspection apparatus 500 receives the job information from the controller 400 (Step S902), and, after the reception, transmits, to the controller 400, a reference image transmission request for inspection determination (Step S904). The CPU 4301 of the controller 400 transmits original image data of the print job as reference image data to the inspection apparatus 500 based on the reference image transmission request received from the inspection apparatus 500 (Step S905). The CPU 5001 of the inspection apparatus 500 receives the reference image from the controller 400 to store the reference image in the storage 5011, and notifies the controller 400 of completion of preparation for the print job (Step S906).

When the CPU 4301 of the controller 400 receives a preparation completion notification from the inspection apparatus 500 (Step S907), the CPU 4301 controls the printer 300 to start the printing (Step S908). After the execution of Step S906, the CPU 5001 of the inspection apparatus 500 determines whether or not a sheet has arrived at a sheet detection position of the sheet detection sensor 504 on the conveying path 501 of the inspection apparatus 500 (Step S910). When a sheet has not arrived (No in Step S910), the CPU 5001 of the inspection apparatus 500 waits for a sheet to arrive. When a sheet has arrived (Yes in Step S910), the CPU 5001 of the inspection apparatus 500 reads the sent sheet by the first reader 5051a and the second reader 5051b, and then instructs the image processor 5006 to perform processing for comparison to the reference image data received in Step S906. Accordingly, the image processor 5006 performs the processing for comparison to perform an image inspection (Step S911).

After that, the CPU 5001 of the inspection apparatus 500 transmits an inspection result of the image inspection based on the comparison performed by the image processor 5006 to the controller 400 (Step S912). The CPU 4301 of the controller 400 determines whether or not the inspection result has been received (Step S914). When the inspection result has not been received (No in Step S914), the CPU 4301 waits for reception of the inspection result. When the inspection result has been received (Yes in Step S914), the CPU 4301 of the controller 400 controls the operating device 200 to update the inspection screen (not shown) based on the inspection result (Step S915).

Next, the CPU 4301 of the controller 400 determines whether or not the inspection result indicates that there is no abnormality (OK) (Step S920). When the inspection result is OK determination (Yes in Step S920), the CPU 4301 of the controller 400 performs the shift discharge control to the large-capacity tray in the stacker 600 (Step S930). When the inspection result is not OK determination (No in Step S920), the CPU 4301 of the controller 400 determines whether or not the number of NG sheets detected successively from the printing start is equal to or larger than a setting value input by the user through the input field B601c (Step S943). When the number is equal to or larger than the setting value (Yes in Step S943), the CPU 4301 of the controller 400 executes interruption of the printing (Step S944), and ends the processing. When the number is not equal to or larger than the setting value (No in Step S943), the CPU 4301 of the controller 400 determines whether or not the radio button B603e is selected, that is, the recovery printing is to be performed (Step S925). When the recovery printing is to be performed (Yes in Step S925), the CPU 4301 of the controller 400 performs control of discharging the NG sheet and the subsequent sheets in the stacker 600 (Step S931), then gives an instruction to re-print the NG sheet (Step S932), and returns the process to Step S910.

When the recovery printing is not to be performed (No in Step S925), the CPU 4301 of the controller 400 determines whether or not the radio button B603a is selected, that is, “Only inspection” is selected (Step S921). When “Only inspection” is selected (Yes in Step S921), the CPU 4301 of the controller 400 performs large-capacity tray discharge control in the stacker 600 (Step S929), and then the process proceeds to Step S916 (described later). In other cases (No in Step S921), the CPU 4301 of the controller 400 determines whether or not the radio button B603c is selected, that is, “Only inspection (2) (Interleaf insertion)” is selected (Step S922). When the radio button B603c is selected (Yes in Step S922), the CPU 4301 of the controller 400 feeds an interleaf (Step S926), and the process proceeds to Step S929. When the radio button B603c is not selected (No in Step S922), the CPU 4301 of the controller 400 determines whether or not the radio button B603b is selected, that is, “Only inspection (1) (Shift discharge)” is selected (Step S923). When the radio button B603b is selected (Yes in Step S923), the large-capacity tray shift discharge control is performed in the stacker 600 (Step S928), and then the process proceeds to Step S916. When the radio button B603b is not selected (No in Step S923), the CPU 4301 of the controller 400 instructs the stacker 600 to perform the purge tray discharge control (Step S927), and then the process proceeds to Step S916.

In Step S916, the CPU 4301 of the controller 400 determines whether or not there is a subsequent page. When there is a subsequent page (Yes in Step S916), the process proceeds to Step S914. When there is no subsequent page (No in Step S916), that is, printing and inspection of all pages have been completed, the CPU 4301 of the controller 400 controls the operating device 200 to update the inspection screen so that completion of the inspection is displayed (Step S917), and ends the main printing inspection processing.

In the example of FIG. 6, as illustrated in FIG. 6, the radio buttons and the input field are set as shown in the group B601 and the sub-group B603, and the setting value of the number of NG sheets is five and the radio button B603e is selected. Therefore, when the inspection result is NG determination (No in Step S920), and the number of NG sheets detected successively from the start of the main printing has reached five, which is the setting value in the input field B601c (Yes in Step S943), the printing is interrupted (Step S944). Meanwhile, when the number of detected NG sheets has not reached five (No in Step S943), because the recovery printing is designated by the radio button B603e (Yes in Step S925), the NG sheet and the subsequent sheets are discharged to the purge tray 620 (Step S931), and the re-printing of the NG sheet is executed (Step S932). Then, the inspection apparatus 500 waits until the printed sheet arrives again (No in Step S910), and when it is determined that the re-printed sheet has arrived to the inspection apparatus 500 (Yes in Step S910), image reading and an inspection (Step S911) are restarted, and the main printing processing is continuously executed.

When the radio button B603d is selected in the sub-group B603, all of the determination results of Step S925, Step S921, Step S922, and Step S923 become No, and the process advances to Step S927 so that the discharge control of discharging the NG sheet to the purge tray 620 is performed and the printing processing is continued. After that, the controller 400 and the inspection apparatus 500 repeat Step S908 to Step S915 until the final page of the job (Step S916).

In the above-mentioned example, the radio button for setting “Only inspection” in FIG. 6 is provided individually for the main printing (radio button B603a) and for the test printing (radio button B604a). However, a common button may be used for the main printing and the test printing. The same holds true also for the radio buttons B603b to B603d and the radio buttons B604b to B604d.

As described above, according to the present disclosure, the discharge settings can be individually set for the time of main printing and the time of test printing. Further, in the test printing, the discharge settings can be changed by a simple operation of setting one check box, and hence, while the operation work of the printing apparatus can be simplified and the work time is shortened, a setting error can be suppressed. Therefore, when the image printed on the sheet in the test printing is inspected, the discharge destination of the inspected sheet can be set.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-041346, filed Mar. 15, 2024, which is hereby incorporated by reference herein in its entirety.

What is claimed is:

1. An image forming system comprising:
an image forming unit configured to form an image on a sheet;
a reader configured to read the image formed on the sheet by the image forming unit;
an inspector configured to execute an inspection of the image read by the reader; and
a selector configured to:
select a discharge destination to which, after an image formed on a first sheet printed as test printing by the image forming unit is inspected by the inspector, the first sheet is to be discharged; and
select a discharge destination to which, after an image formed on a second sheet printed as main printing is inspected by the inspector, the second sheet is to be discharged.

2. The image forming system according to claim 1,
wherein the image forming unit is configured to form the image based on a print job, and
wherein the main printing is printing for executing the entire print job.

3. The image forming system according to claim 1, wherein the selector is configured to determine the discharge destination of the sheet based on whether a result of the inspection is determined as having no abnormality or having an abnormality.

4. The image forming system according to claim 2,
wherein the selector is operable to receive, from a user, a forced discharge destination setting of setting, in the test printing, the discharge destination of the sheet to a forced-discharge tray, and
wherein, when the forced discharge destination setting has been received from the user, the discharge destination of the sheet printed as the test printing is set to the forced-discharge tray.

5. The image forming system according to claim 3, wherein the discharge destination of the sheet for which the result of the inspection is determined as having an abnormality is set to one tray different from the discharge destination of the sheet for which the result of the inspection is determined as having no abnormality.

6. The image forming system according to claim 2, wherein a setting of processing to be performed on the image after the inspection is receivable from the user individually for the main printing and the test printing.

7. The image forming system according to claim 5, wherein processing to be performed on the image after the inspection is at least one of shift discharge and interleaf insertion.

8. The image forming system according to claim 2, wherein, in a setting of the discharge destination, the discharge destination of the sheet for which a result of the inspection is determined as having an abnormality is set to a tray different from the discharge destination of the sheet for which the result of the inspection is determined as having no abnormality.

9. The image forming system according to claim 2, further comprising:
a first receiver configured to receive an operation of giving an instruction to execute the main printing; and
a second receiver configured to receive an operation of giving an instruction to execute the test printing,
wherein the inspector is configured to execute the inspection in any one of a case in which the operation of giving the instruction to execute the main printing has been received from the first receiver and a case in which the operation of giving the instruction to execute the test printing has been received from the second receiver.

10. The image forming system according to claim 2, wherein the inspector is configured to execute the inspection in any one of a case in which the main printing is executed and a case in which the test printing is executed.

11. A discharge destination setting apparatus to be used in an image forming system including an image forming unit and an inspector configured to execute an inspection of an image obtained by reading an image formed on a sheet by the image forming unit, the discharge destination setting apparatus comprising:
a display; and
a display controller configured to cause the display to display a screen,
wherein the display is configured to display a screen for use in selecting a discharge destination to which, after an image formed on a first sheet printed as test printing by the image forming unit is inspected by the inspector, the first sheet is to be discharged, and selecting a discharge destination to which, after an image formed on a second sheet printed as main printing is inspected by the inspector, the second sheet to is be discharged.

12. The discharge destination setting apparatus according to claim 11,
wherein the image forming unit is configured to form the image based on a print job, and
wherein the main printing is printing for executing the entire print job.

13. The discharge destination setting apparatus according to claim 11, wherein the discharge destination setting apparatus is configured to determine the discharge destination of the sheet based on whether a result of the inspection is determined as having no abnormality or having an abnormality.

14. The discharge destination setting apparatus according to claim 12,
wherein the display is configured to display a screen for receiving, from a user, a forced discharge destination setting of setting, in the test printing, the discharge destination of the sheet to a forced-discharge tray, and
wherein, in the discharge destination setting apparatus, when the forced discharge destination setting has been received from the user, the discharge destination of the sheet printed as the test printing is set to the forced-discharge tray.

15. The discharge destination setting apparatus according to claim 13, wherein, in the discharge destination setting apparatus, the discharge destination of the sheet for which the result of the inspection is determined as having an abnormality is set to one tray different from the discharge destination of the sheet for which the result of the inspection is determined as having no abnormality.

16. The discharge destination setting apparatus according to claim 12, wherein the display is configured to display a screen for receiving, from a user, a setting of processing to be performed on the image after the inspection individually for the main printing and the test printing.

17. The discharge destination setting apparatus according to claim 15, wherein, in the image forming system, processing to be performed on the image after the inspection is at least one of shift discharge and interleaf insertion.

18. The discharge destination setting apparatus according to claim 12, wherein, in the discharge destination setting apparatus, in a setting of the discharge destination, the discharge destination of the sheet for which a result of the inspection is determined as having an abnormality is set to a tray different from the discharge destination of the sheet for which the result of the inspection is determined as having no abnormality.

19. The discharge destination setting apparatus according to claim 12,
wherein the image forming system further includes:
a first receiver configured to receive an operation of giving an instruction to execute the main printing; and
a second receiver configured to receive an operation of giving an instruction to execute the test printing, and
wherein the inspector is configured to execute the inspection in any one of a case in which the operation of giving the instruction to execute the main printing has been received from the first receiver and a case in which the operation of giving the instruction to execute the test printing has been received from the second receiver.

20. The discharge destination setting apparatus according to claim 12, wherein the inspector is configured to execute the inspection in any one of a case in which the main printing is executed and a case in which the test printing is executed.
